(19) United States
(12) Patent Application Publication
(10) Pub. No.: US 2008/0268999 A1
(43) Pub. Date: Oct. 30, 2008

(54) Friction Wheel Drive

(75) Inventors: Thomas Kraft, Neuhof-Zenn (DE); Johann Singer, Grossenseebach (DE); Michael Bogner, Eckental (DE); Ralf Walter, Aachen (DE); Horst Adel, Rochester Hills, MI (US); Diethard Sauermann, Bubenreuth (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/570,380

(22) PCT Filed: May 19, 2005
(86) PCT No.: PCT/EP05/05430

§ 371 Date: Feb. 8, 2007

(30) Foreign Application Priority Data
Jun. 11, 2004 (DE) 102004028484.9

(51) Int. Cl. F16H 13/14

(52) U.S. Cl. 475/185

(57) ABSTRACT

A friction wheel drive, especially for driving an auxiliary unit of an internal combustion engine in a frictionally engaging manner is provided. The friction wheel drive includes an adjustable friction wheel (3, 3′) which can be pressed at least against a contact disk (7, 9) of an output member (8) and/or an input member (10). In order to create a particularly simple, mechanically operating friction wheel (3, 3′), the friction wheel is provided with a running disk (5) which is mounted on a rolling bearing (19) that is fixed to the engine. The running disk (5) includes a tapered annular groove (24) having a width that can be varied by axially movable, spring-force impinged sidewalls (21). Further, a friction ring (4, 4′) having a diameter that is larger than that of the tapered annular groove (24) is inserted into the groove such that the friction ring (4, 4′) is disposed eccentric to the same, is guided in a radially movable fashion, and is spring mounted.

### BACKGROUND

The invention relates to a friction wheel drive for the frictionally engaged driving of an auxiliary unit of an internal combustion engine, with an adjustable friction wheel, which can be pressed at least against one contact disk of a driven and/or drive element.

Alternatively, a friction wheel drive with an adjustable friction wheel is presented, which can be pressed against the contact disk of a drive element and which has a self-propulsion unit.

From DE 196 35 808 A1, a friction wheel drive of the construction named above is known. This publication relates to a friction wheel drive designed for a vehicle. It is used to assist the conventional drive of the vehicle when needed through an auxiliary drive for the vehicle wheels that are normally not driven.

The friction wheel drive includes an electric motor, which, via a transmission, drives a friction wheel that is adjustable in the direction of the wheel rim when needed. The wheels driven electrically by means of the friction wheel drive assist the conventionally driven wheels when there is too little static friction, which can occur, for example, when there is clear ice or when the conventional drive supplies too little power, e.g., on inclines that are too steep.

A disadvantage in the friction wheel drive described above is that a large number of additional components are necessary due to its standalone drive, which increases the likelihood of faults and also the necessary installation space and the weight of the system.

For a friction wheel drive of an auxiliary unit, in which the friction wheel is arranged near to the engine and fixed between the crankshaft and the auxiliary unit and in which the contact pressure force of the friction wheel is designed for transmitting the drive moment of the auxiliary unit, possible manufacturing tolerances, e.g., in the position of the auxiliary unit and in the belt thickness and also temperature differences of the components and eccentricity and also wear cause an impermissible reduction of the contact pressure force with corresponding slippage. Therefore, an increase in the contact pressure force is necessary in advance, which results in increased flexing work with friction heating and premature wear.

### SUMMARY

The invention is based on the objective of creating a friction wheel drive for an auxiliary unit of an internal combustion engine, wherein the friction wheel drive maintains the contact pressure force of the friction wheel required for the frictionally engaged transfer of the drive moment with little constructional expense.

The objective is met according to the invention by the features of the independent claim 1. Additional advantageous configurations of the invention are the subject matter of the dependent claims 2 to 10.

Because the friction ring is in frictionally engaged pressure contact with the contact disks of the driven and drive elements through the spring means acting on the two side walls in the axial direction, all of the dimensions that are smaller than specified in the frictionally engaged partners are equalized through radial displacement of the friction ring. Because the dimensions that are smaller than specified have only small values, their equalization through a small radial movement of the friction ring out of the tapered ring groove causes an only small reduction of the contact pressure force. Conversely, the spring mounting of the friction ring permits an expansion of the friction ring into the tapered ring groove when the friction partners have larger dimensions than specified, whereby the contact pressure force peaks of a rigid friction wheel are prevented. Through the automatic matching of the radial position of the friction ring to its respective situation with dimensions that are smaller or larger than specified, its contact pressure force changes only slightly. In this way, wear of the friction ring caused by slippage or pressure overloading is prevented.

An advantage for an exact construction and function of the width-adjustable tapered ring groove is that the running disk has a round-cylindrical sleeve, on which a cylindrical section of the side walls is guided in the axial direction. This cylindrical section is connected rigidly to a conical section of the side walls and together, these sections form the width-adjustable tapered ring groove.

Small axial space requirements are achieved, in that the spring means are constructed as disk springs, which are supported on the end contacts of the round-circular sleeve and on the conical section of the side walls.

A decreasing spring characteristic curve of the disk spring combines the advantage of small axial space requirements through the initially rapid rise of the spring force with a slightly rising spring force in the end region of the spring travel. In this way, small positional changes in the friction ring have only insignificant effects on the contact pressure force of the friction wheel.

Pre-setting the friction ring is achieved during the assembly of the friction wheel, such that the eccentricity and thus the contact pressure force of the friction ring contacting the contact disks of the driven and drive elements is pre-set through the displacement of the engine-fixed roller bearing along an effective tensioning line of the running disk. The exact magnitude of the eccentricity of the friction ring is automatically set under the prevailing initial conditions, e.g., of the component temperature and the wear of the friction partners with the help of the spring-mounted friction ring.

Conical friction rings made from steel or light metal are particularly well suited for high contact pressure forces, because the relatively large, conical contact surfaces of the friction ring and the tapered ring groove cause a relatively small surface pressure between these surfaces, which generates a correspondingly low wear.

If only a small contact pressure force is sufficient for the transfer of the torque of the auxiliary unit, a round or elliptical cross section of the friction ring offers advantages, especially when this is hollow and made from an elastomeric material. Similar to a pneumatic tire, its contact pressure surface adapts without a problem to the unevenness and dimensional deviations of the friction partners, without causing greater fluctuations in the contact pressure force.

Due to the dry sliding friction prevailing between the components of the friction wheel, their relative motion is damped, which causes low-vibration running of the friction wheel.

An especially simple solution of the traction mechanism drive combined with the friction wheel drive is achieved, such that the driven element is not constructed as a traction mechanism surrounding the contact belt or V-belt disk of the crankshaft, but instead it is constructed as a loose section of the traction mechanism, which is used as a normal belt for driving, for example, a generator and an air-conditioner compressor. In this case, the friction wheel is simultaneously a deflection and contact roller for the loose section.

### BRIEF DESCRIPTION OF THE DRAWINGS

Additional features of the invention emerge from the following description and the drawings, in which an embodiment of the invention is shown schematically. Shown are:

FIG. 1 is a view of a combined friction wheel and traction mechanism drive with a friction wheel according to the invention, which is in indirect pressure contact with a contact disk of a driven element;

FIG. 2 is a view of a combined friction wheel and traction mechanism drive according to FIG. 1, in which the friction wheel according to the invention is in direct pressure contact with a loose section of the traction mechanism drive;

FIG. 3 is a longitudinal section view through the friction wheel according to the invention with a friction ring of wedge-shaped cross section;

FIG. 4 is a longitudinal section view as in FIG. 3, but with a friction ring of oval cross section.

### DETAILED DESCRIPTION OF THE PREFERRED EMBODIMENTS

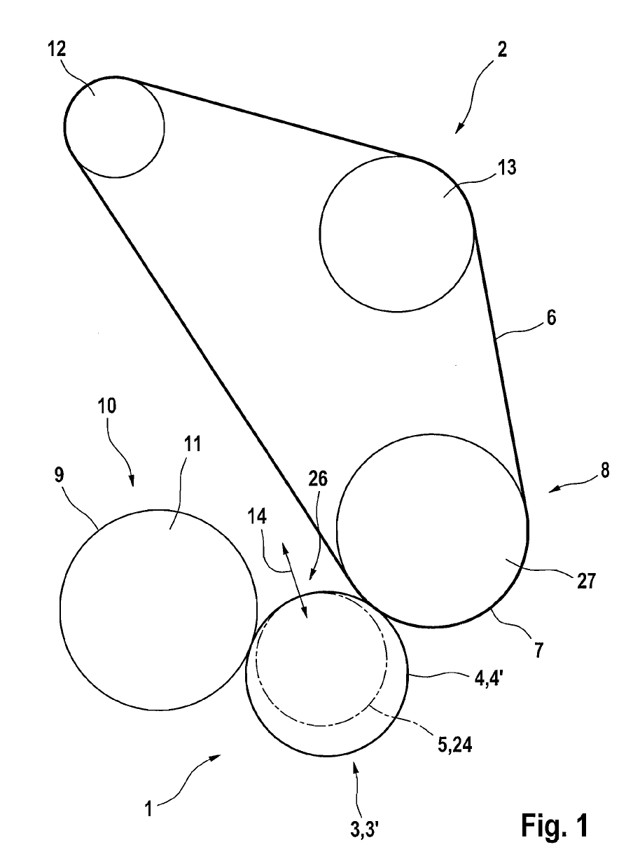

In FIG. 1, a view of a friction wheel drive 1 is shown, which is combined with a traction mechanism drive 2.

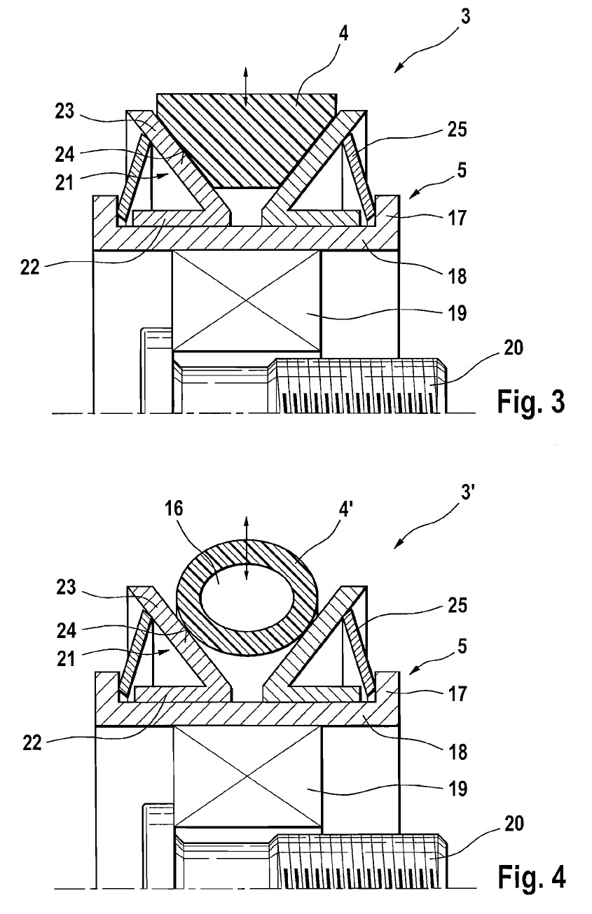

The friction wheel drive 1 comprises a friction wheel 3, 3′ according to the invention, which contains a friction ring 4, 4′ that is mounted so that it can move in the radial direction in a tapered ring groove 24 of an engine-fixed running disk 5. The construction of the friction wheel 3, 3′ is discussed in more detail in the description of FIGS. 3 and 4. The friction ring 4, 4′ is in indirect, frictionally engaged connection with a contact or V-belt disk 7 of a driven element 8 of a crankshaft 27 surrounded by a traction mechanism 6, while it is in direct frictional contact with a contact disk 9 of a drive element 10 of an auxiliary element 11. The auxiliary element 11 involves, for example, a coolant pump. The traction mechanism drive 2 is used for driving a generator 12 and an air-conditioner compressor 13. For this purpose, the traction mechanism 6, which is constructed as a normal belt, connects all of the associated contact disks to the contact disk 7, which is locked in rotation with the crankshaft and simultaneously forms the driven element 8.

For pre-setting the contact pressure force of the friction ring 4, 4′, which contacts the contact disks 7 and 9, the running disk 5 is displaced on an effective tensioning line 14 shown by an arrow. Here, the friction ring 4, 4′ reaches the region of its deepest insertion 26 into the tapered ring groove 24.

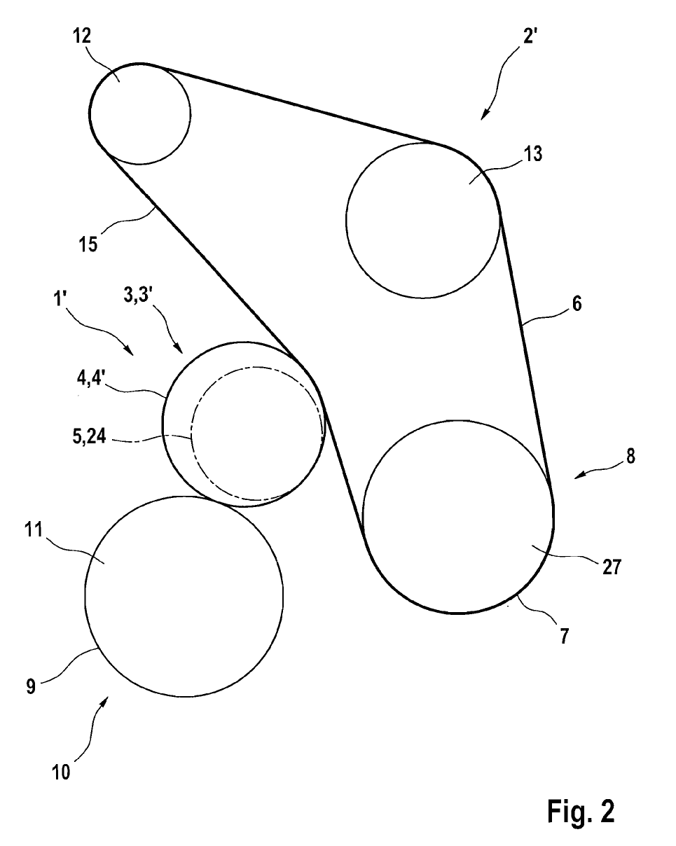

In FIG. 2, a view of an alternative friction wheel drive 1′ and an alternative traction mechanism drive 2′ combined with this friction drive is shown. These are characterized by the position of the friction wheel 3, 3′ relative to the traction mechanism 6. Here, a loose section 15 of the traction mechanism 6, which is in direct, frictionally engaged contact with the friction ring 4, 4′ like the contact disk 9 of the auxiliary unit 11, is used as the driven element. In this way, the friction ring 4, 4′ is used simultaneously as a deflection and contact roller for the loose section 15.

FIG. 3 shows a longitudinal section through the friction wheel 3 according to the invention. This has a running disk 5 and a friction ring 4. The running disk 5 has a round-cylindrical sleeve 18, which is mounted on a roller bearing 19. The roller bearing 19 is connected rigidly to an engine housing (not shown) by a tension screw 20. Two equal side walls 21, which are in a mirror-inverted arrangement and which can move in the axial direction, are located on the sleeve 18. The side walls 21 are each composed of a cylindrical section 22 and a conical section 23 connected rigidly to this cylindrical section. The cylindrical section 22 is used as the axial guide for the side walls 21 on the sleeve 18. The conical sections 23 together form a width-adjustable tapered ring groove 24 for the friction ring 4. The friction ring has a greater diameter than the tapered ring groove 24.

The side walls 21 are acted upon by counteracting, axial spring forces. In the present case, a disk spring 25 is provided, which is supported on end stops 17 of the sleeve 18 and on the conical sections 23 of the side walls 21. They are constructed with slots and have a decreasing characteristic curve. Through the spring forces acting on the side walls 21, the friction ring 4 is clamped between these walls and experiences a radial force component, which acts as a contact pressure force on the contact disks 7, 9 or on the loose section 15 of the traction mechanism 6, due to the tapered ring-shaped, smooth flanks of the tapered ring groove 24 and the friction ring 4.

Because the side walls 21 of the tapered ring groove 24 yield elastically, the friction ring 4 can adapt to the unevenness and dimensional deviations of the friction partner automatically. For the small radial movements of the friction ring 4 in question, the fluctuations of its contact pressure force are small, so that overloading of the friction wheel 3 or slippage of this component is prevented.

FIG. 4 differs from FIG. 3 only by the friction ring 4′, which has an oval or circular cross section with a ring-shaped hollow space 16 and which is made from polymer material. The friction ring 4′ adapts flexibly to the possible unevenness and dimensional deviations of the friction partners in a similar manner to a pneumatic tire and thus prevents large fluctuations in the contact pressure force of the friction wheel 3′.

### REFERENCE SYMBOLS

1, 1′ Friction wheel drive
2, 2′ Traction mechanism drive
3, 3′ Friction wheel
4, 4′ Friction ring
5 Running disk
6 Traction mechanism
7 Contact disk/belt disk (driven element)
8 Driven element
9 Contact disk (drive element)
10 Drive element
11 Auxiliary unit
12 Generator
13 Air-conditioner compressor
14 Effective tensioning line (arrow)
15 Loose section
16 Hollow space
17 End stop
18 Sleeve
19 Roller bearing
20 Tensioning screw
21 Side wall
22 Cylindrical section
23 Conical section
24 Tapered ring groove
25 Disk spring
26 Deepest insertion of friction ring
27 Crankshaft

1. Friction wheel drive for frictionally engaged driving of an auxiliary unit of an internal combustion engine, comprising an adjustable friction wheel, which can be pressed at least against a contact disk of a driven element and/or a drive element, the friction wheel has a running disk mounted on an engine-fixed roller bearing and includes a tapered ring groove, having a width that can be varied through side walls that are adjustable in an axial direction and that are acted upon by spring forces, and a friction ring, having a diameter greater than that of the tapered ring groove, is inserted into the groove, so that the friction ring is arranged eccentrically to the friction wheel and is guided and also spring-mounted so that it can move in the groove in the radial direction, wherein the friction ring is acted upon with a radial force that leads to a frictionally engaged pressure contact of the friction wheel with the contact disk of the driven and drive elements by side walls acted upon by springs in the axial direction in an area of a deepest insertion into the tapered ring groove.

2. Friction wheel drive according to claim 1, wherein the running disk has a round-cylindrical sleeve, which is mounted on the engine-fixed roller bearing and on which a cylindrical section of the side walls are guided in the axial direction.

3. Friction wheel drive according to claim 2, wherein the cylindrical section of the side walls are connected rigidly to a conical section thereof, which together form the tapered ring groove with the adjustable width for the friction ring.

4. Friction wheel drive according to claim 3, wherein the spring means comprise disk springs, which are supported on end stops of the round-cylindrical sleeve and on the conical sections of the side walls.

5. Friction wheel drive according to claim 4, wherein a spring characteristic curve of the disk springs has a decreasing configuration.

6. Friction wheel drive according to claim 5, wherein an eccentricity and thus a contact pressure force of the friction ring contacting the contact disks of the driven and drive elements can be pre-set by moving the engine-fixed roller bearing along an effective tensioning line of the running disk.

7. Friction wheel drive according to claim 6, wherein a cross section of the friction ring has a wedge shape, which corresponds to a cross section of the tapered ring groove formed by the side walls, wherein the wedge-shaped friction ring.

8. Friction wheel drive according to claim 6, wherein a cross section of the friction ring is circular or oval shaped and has a ring-shaped hollow space.

9. Friction wheel drive according to claim 1, wherein at least partially dry sliding friction prevails for relative movement between the components of the friction wheel.

10. Friction wheel drive according to claim 9, wherein the driven element comprises a traction mechanism surrounding contact belt or V-belt disk of a crankshaft or a loose section of a traction mechanism drive, whose traction mechanism constructed as a normal belt is used for driving a generator and an air-conditioner compressor.

11. Friction wheel drive of claim 7, wherein the friction ring is made of steel or metal.

12. Friction wheel drive of claim 8, wherein the friction ring is made of an elastomeric material.
